(19) United States
(12) Patent Application Publication
(10) Pub. No.: US 2025/0113939 A1
(43) Pub. Date: Apr. 10, 2025

(54) COOKING APPARATUS

(71) Applicant: SAMSUNG ELECTRONICS CO., LTD., Suwon-si (KR)

(72) Inventors: Sooncheol KWEON, Suwon-si (KR); Minjung KWON, Suwon-si (KR); Jaegyeong MA, Suwon-si (KR); Minjae LEE, Suwon-si (KR); Chanyoung CHOI, Suwon-si (KR)

(73) Assignee: SAMSUNG ELECTRONICS CO., LTD., Suwon-si (KR)

(21) Appl. No.: 18/782,401

(22) Filed: Jul. 24, 2024

Related U.S. Application Data
(63) Continuation of application No. PCT/KR2024/009845, filed on Jul. 10, 2024.

(30) Foreign Application Priority Data
Oct. 6, 2023 (KR) 10-2023-0133723

(51) Int. Cl. A47J 27/00; A47J 36/32

(52) U.S. Cl. CPC A47J 27/002; A47J 36/32

(57) ABSTRACT

A cooking apparatus may include a housing forming a cooking chamber, a turntable in the cooking chamber on which an object is placeable, a motor configured to rotate the turntable, a heating source configured to heat the object on the turntable, a roller supporting the turntable and which is movable, according to rotation of the turntable by the motor, on a roller track surface on an inner surface of the housing, a lever protruding from the roller track surface toward the cooking chamber and configured to be pressable by pressure from the roller, and thereby operated, when the object is on the turntable and the roller moves over the lever, and a sensor configured to sense that the lever is operated and to generate a signal corresponding to the lever being operated, wherein an operation of the heating source and the motor is controlled based on the signal.

### CROSS-REFERENCE TO RELATED APPLICATIONS

This is a continuation application, under 35 U.S.C. § 111(a), of International Application No. PCT/KR2024/009845, filed Jul. 10, 2024, which claims priority under 35 U.S.C. § 119 to Korean Patent Application No. 10-2023-0133723, filed Oct. 6, 2023, in the Korean Intellectual Property Office, the disclosures of which are incorporated herein in their entireties by reference.

### TECHNICAL FIELD

The disclosure relates to a cooking apparatus with improved safety of use.

### BACKGROUND ART

Cooking apparatuses are devices for cooking foods by heating, which provide various functions related to cooking, such as heating, thawing, drying, and sterilizing of an object to be cooked. The cooking apparatuses may include, for example, ovens such as gas ovens or electric ovens, microwave heating devices (also referred to as microwaves), gas ranges, electric ranges, over the ranges (OTRs), gas grills or electric grills.

The microwave is a device for cooking food with frictional heat produced by disturbing the arrangement of water molecules in the food through electromagnetic waves. The oven is a device for cooking food by transferring heat directly to the food or heating the inside of the cooking chamber by means of a heating source that produces heat, such as a heater.

A turntable of the microwave is placed inside the cooking chamber, and food may be cooked on the turntable. The turntable is rotatably disposed in the cooking chamber to evenly heat the entire surface of the food. The turntable may be coupled by a coupler to a rotation motor disposed below and outside the cooking chamber, and a roller may be disposed below the turntable to rotatably support the turntable in the cooking chamber.

### DISCLOSURE

### Technical Problem

An aspect of the disclosure provides a cooking apparatus with improved safety of use.

An aspect of the disclosure provides a cooking apparatus that may confirm whether a turntable rotates.

An aspect of the disclosure provides a cooking apparatus that may control a heating source and a motor based on whether a turntable rotates.

An aspect of the disclosure provides a cooking apparatus that may provide a user with information based on whether a turntable rotates.

An aspect of the disclosure provides a cooking apparatus that may allow a user to confirm whether an object to be cooked is placed on a turntable.

An aspect of the disclosure provides a cooking apparatus that may control a heating source and a motor based on whether an object to be cooked is placed on a turntable.

An aspect of the disclosure provides a cooking apparatus that may provide a user with information based on whether an object to be cooked is placed on a turntable.

Technical objects that can be achieved by the disclosure are not limited to the above-mentioned objects, and other technical objects not mentioned will be clearly understood by one of ordinary skill in the art to which the disclosure belongs from the following description.

### Technical Solution

According to an aspect of the disclosure, a cooking apparatus may include a housing forming a cooking chamber. The cooking apparatus may include a turntable in the cooking chamber on which an object to be cooked is placeable. The cooking apparatus may include a motor configured to rotate the turntable. The cooking apparatus may include a heating source configured to heat the object to be cooked on the turntable inside the cooking chamber. The cooking apparatus may include a roller supporting the turntable and which is movable, according to rotation of the turntable by the motor, on a roller track surface formed on an inner surface of the housing. The cooking apparatus may include a lever protruding from the roller track surface toward the cooking chamber and configured to be pressable by pressure from the roller, and thereby operated, when the object to be cooked is on the turntable and the roller moves over the lever. The cooking apparatus may include a sensor configured to sense that the lever is operated by pressure from the roller and to generate a signal corresponding to the lever being operated. An operation of the heating source and the motor may be controlled based on the input signal.

The lever may further include: a rotation portion which is rotatable about a rotation axis of the lever, a pressing portion may be configured to press the sensor based on rotation of the rotation portion, and a protrusion may be between the rotation axis and the pressing portion, protruding from the roller track surface toward the cooking chamber, and may be configured to be pressable by the pressure from the roller, and the sensor may generate the signal by being pressed by a rotational movement of the lever about the rotation axis.

The lever may further include: a lever body configured to rotate about the rotation axis, and the protrusion may protrude from an upper surface of the lever body toward the cooking chamber, and the pressing portion may be on a lower surface of the lever body.

The lever may not be operated by the pressure from the roller when the roller moves over the lever without an object being on the turntable.

The inner surface of the housing may include a through hole formed through the roller track surface, and the protrusion may pass through the through hole and protrude toward the cooking chamber.

The sensor may be spaced apart from the through hole in a radial direction of the turntable.

The lever may further include: a through hole cover which may be coupled to the protrusion and may be inserted into the through hole to cover the through hole, and the through hole cover may press the protrusion when the through hole cover is pressed by the roller.

The through hole cover may include: a support surface to support the roller when the roller moves over the through hole cover, and an inclined surface extending from the roller track surface toward the support surface, and curved toward the cooking chamber to guide the roller to the support surface from the roller track surface.

According to an aspect of the disclosure, the cooking apparatus may further include: a processor configured to receive the signal. The processor may be further configured to control the operation of the heating source and the motor based on the signal.

The processor may be further configured to: count time, determine a progress time that elapsed without receiving the signal, and stop the operation of the heating source and the motor in response to the progress time being greater than or equal to a pre-stored progress time.

According to an aspect of the disclosure, the cooking apparatus may further include a display connected to the processor. The processor may be further configured to control the display to display a pre-stored error phrase in response to the progress time being greater than or equal to the pre-stored progress time.

The processor may be further configured to: determine a display count of a number of times the pre-stored error phrase is displayed on the display, and control the display to display a pre-stored service call phrase in response to the display count being greater than or equal to a pre-stored value.

The processor may be further configured to: count time, determine a first input signal based on receiving the signal, determine a first input time based on a time that the first input signal is determined, determine a second input signal based on the signal first received after determining the first input signal, determine a second input time based on a time that the second input signal is determined, determine a required time from time elapsed between the first input time and the second input time, and stop the operation of the heating source and the motor in response to the required time being greater than or equal to a pre-stored required time.

According to an aspect of the disclosure, the cooking apparatus may further include a display connected to the processor. The processor may be further configured to control the display to display a pre-stored error phrase in response to the required time being greater than or equal to the pre-stored required time.

The processor may be further configured to: determine a display count of a number of times the pre-stored error phrase is displayed on the display, and control the display to display a pre-stored service call phrase in response to the display count being greater than or equal to a pre-stored value.

According to an aspect of the disclosure, a cooking apparatus may include a housing configured to form a cooking chamber. The cooking apparatus may include a heating source configured to heat an inside of the cooking chamber. The cooking apparatus may include a turntable on which an object to be cooked is placed and configured to be connected to a motor and rotatably disposed in the cooking chamber. The cooking apparatus may include a roller configured to support the turntable and be movable according to rotation of the turntable on an inner surface of the housing. The cooking apparatus may include a lever including a protrusion configured to protrude toward the cooking chamber on the inner surface of the housing so as to be pressed by the roller. The lever may be configured to be operated by pressure from the roller based on whether the object to be cooked is placed on the turntable. The cooking apparatus may include a sensor configured to sense an operation of the lever upon the operation of the lever to generate an input signal. The cooking apparatus may include a processor configured to be electrically connected to the sensor to receive the input signal. The processor may control an operation of the heating source and the motor based on the input signal.

### DESCRIPTION OF DRAWINGS

FIG. 1 illustrates a cooking apparatus according to an embodiment.

FIG. 2 is an exploded view of a top cover and a bottom cover of a cooking apparatus according to an embodiment.

FIG. 3 is an exploded view illustrating only a housing, a turntable assembly, a signal generator, and a bottom cover of a cooking apparatus according to an embodiment.

FIG. 4 is a view of FIG. 3 from a different direction.

FIG. 5 is a view illustrating a signal generator according to an embodiment.

FIG. 6 is a partial cross-sectional view illustrating the coupled housing, turntable assembly, signal generator, and bottom cover of FIG. 3 taken along A-A′.

FIG. 7 is an enlarged view of an area A of FIG. 6.

FIG. 8 is a view illustrating that when there is no food on the turntable in FIG. 7, a lever does not rotate even though a roller presses a protrusion.

FIG. 9 is a view illustrating that when there is food on the turntable in FIG. 7, a roller presses a protrusion and rotates a lever to operate a sensor.

FIG. 10 is a partial cross-sectional view illustrating the coupled housing, turntable assembly, signal generator, and bottom cover of FIG. 3 taken along B-B′.

FIG. 11 is a view illustrating a roller of FIG. 10 moves past an inclined surface of a through hole cover to a support surface.

FIG. 12 is a control block diagram illustrating a process of controlling a heating source, a motor, and a display of a cooking apparatus according to an embodiment.

FIG. 13 is a flowchart illustrating a method of controlling a heating source and a motor based on whether a processor receives an input signal in a cooking apparatus according to an embodiment.

FIG. 14 is a flowchart illustrating a method of controlling a display based on whether a processor receives an input signal in a cooking apparatus according to an embodiment.

FIG. 15 is a flowchart illustrating a method in which a processor controls a display based on a display count in a cooking apparatus according to an embodiment.

FIG. 16 is a flowchart illustrating a method in which a processor controls a heating source and a motor in response to receiving an input signal, in a cooking apparatus according to an embodiment.

FIG. 17 is a flowchart illustrating a method in which a processor controls a display in response to receiving an input signal, in a cooking apparatus according to an embodiment.

FIG. 18 is a flowchart illustrating a method in which a processor controls a display based on a display count in a cooking apparatus according to an embodiment.

### MODES OF THE DISCLOSURE

Embodiments described in the specification and configurations shown in the accompanying drawings are merely examples of the disclosure, and various modifications may replace the embodiments and the drawings of the disclosure at the time of filing of the application.

Like reference numerals may be used for like or related elements throughout the drawings.

The terms used herein are used only to describe particular embodiments and are not intended to limit the disclosure. The singular form of a noun corresponding to an item may include one or more items unless the context states otherwise. It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

It will be understood that, although the terms “first,” “second,” etc. may be used herein to describe various elements, the elements are not restricted by the terms, and the terms are only used to distinguish one element from another. For example, a first element could be termed a second element, and similarly, a second element could be termed a first element without departing from the scope of the disclosure. The term “and/or” includes combinations of one or all of a plurality of associated listed items.

The terms “front”, “rear”, “left”, “right”, “upper”, “lower”, and the like as herein used are defined with respect to the drawings, but the terms may not restrict the shape and position of the respective components.

An expression that one component is “connected”, “coupled”, “supported”, or “in contact” with another component includes a case in which the components are directly “connected”, “coupled”, “supported”, or “in contact” with each other and a case in which the components are indirectly “connected”, “coupled”, “supported”, or “in contact” with each other through a third component.

It will be understood that when one component is referred to as being “on” or “over” another component, it can be directly on the other component or intervening components may also be present.

A clockwise direction may be expressed as a first direction, and a counterclockwise direction, which is the opposite direction of the first direction, may be expressed as a second direction. These terms may be used to describe specific details for carrying out the disclosure, but the rotation direction of the components of the disclosure is not limited by these terms.

Hereinafter, a cooking apparatus according to various embodiments is described in detail with reference to accompanying drawings.

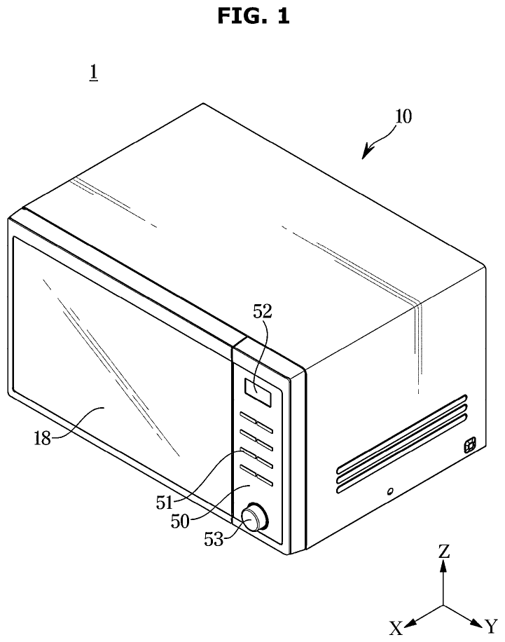

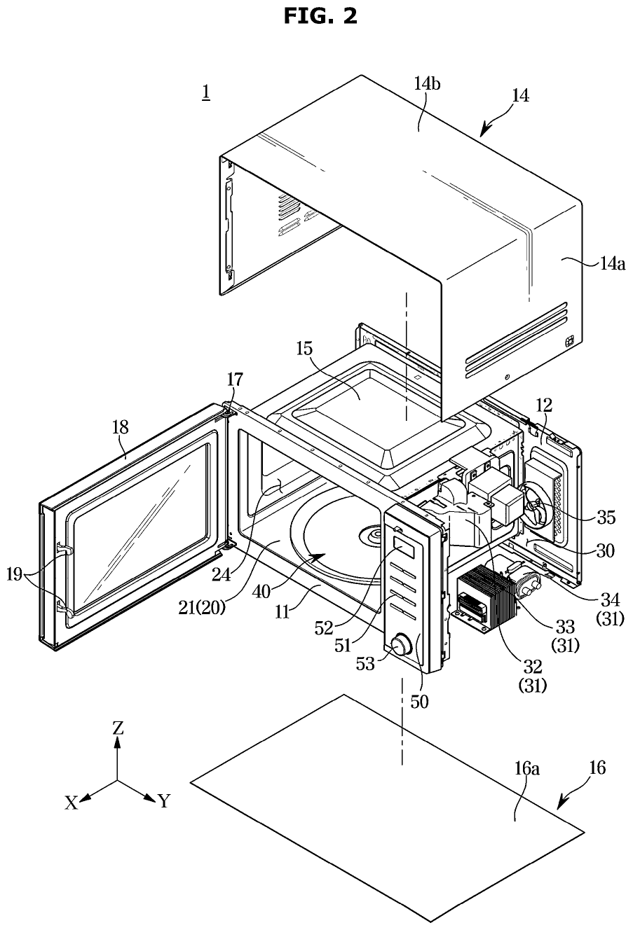

FIG. 1 illustrates a cooking apparatus according to an embodiment. FIG. 2 is an exploded view of a top cover and bottom cover of a cooking apparatus according to an embodiment.

Referring to FIG. 1 and FIG. 2, a cooking apparatus 1 may include a main body 10 forming an exterior of the cooking apparatus 1. The main body 10 may include a front panel 11, a rear panel 12, and a top panel 15. In addition, the main body 10 may include a top cover 14 covering an upward side (+Z direction) of the main body 10 and a bottom cover 16 covering a downward side (−Z direction) of the main body 10.

The top cover 14 may be disposed between the front panel 11 and the rear panel 12. The top cover 14 may be disposed to cover a top surface of the main body 10. The top cover 14 may include a side cover 14a and a top surface cover 14b. The side cover 14a and the top surface cover 14b may be integrally formed. Alternatively, the side cover 14a and the top surface cover 14b may be separately formed.

The bottom cover 16 may be disposed between the front panel 11 and the rear panel 12. The bottom cover 16 may be disposed to cover a bottom of the main body 10.

The cooking apparatus 1 may include a housing 20 forming a cooking chamber 24. The cooking chamber 24 may be formed in the housing 20. The housing 20 may be provided in the main body 10. The housing 20 may have an approximately rectangular shape with open front (+X direction), rear (−X direction), and upper sides.

An electronic equipment chamber 30 may be formed between partition walls 22a and 22b and the top cover 14.

The cooking apparatus 1 may include a heating source 31 for heating the interior of the cooking chamber 24 to cook an object to be cooked D (hereinafter referred to as “cooking object”). For example, the heating source 31 may include a magnetron 32 to generate high frequency waves to be supplied into the cooking chamber 24, a high-voltage transformer 33 to apply a high voltage to the magnetron 32, and a high-voltage condenser 34. The magnetron 32, the high-voltage transformer 33, and the high-voltage condenser 34 may be located in the electronic equipment chamber 30. The cooking apparatus 1 may include a cooling fan 35 for cooling components inside the electronic equipment chamber 30. The cooling fan 35 may be located in the electronic equipment chamber 30.

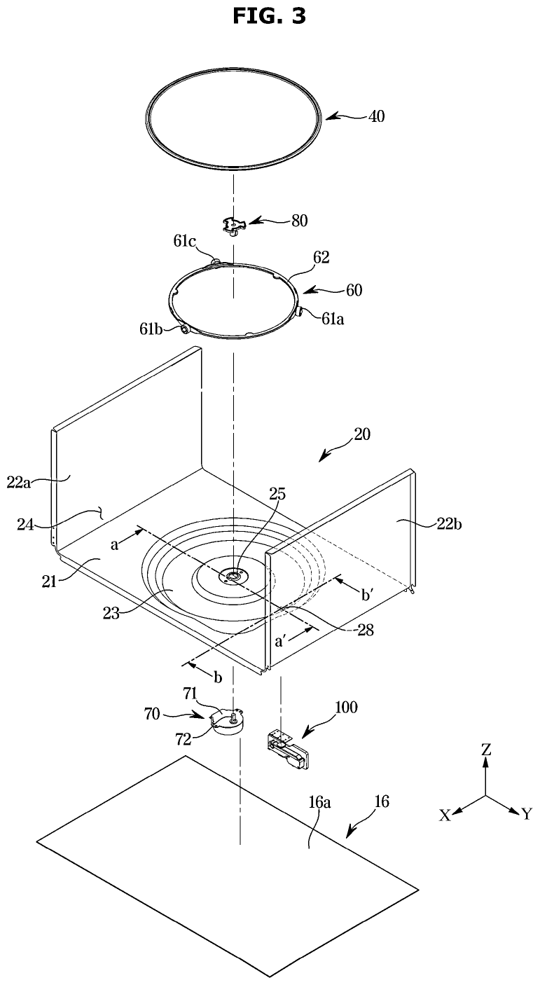

The cooking apparatus 1 may include a turntable 40 on which the cooking object D is placed inside the cooking chamber 24. The turntable 40 may be connected to a motor 70 (see FIG. 3) and may be rotatable in the cooking chamber 24. The turntable 40 may be supported on an internal support surface 21 (see FIG. 3). The cooking object D may be placed on the turntable 40 and may be cooked in the cooking chamber 24.

The cooking apparatus 1 may include a waveguide arranged to guide the high frequency waves radiated from the magnetron 32 into the cooking chamber 24.

The cooking apparatus 1 may cook the cooking object D as the high frequency waves radiate into the cooking chamber 24 while the cooking object D is placed on the turntable 40. The cooking apparatus 1 may cook the cooking object D with frictional heat between molecules produced from repetitive changes in arrangement of water molecules contained in the cooking object D on the turntable 40 by radiating high frequency waves into the cooking chamber 24. While the cooking object D is cooked, the turntable 40 is rotated by the motor 70, and thus the cooking object D may be heated and cooked in a multifaceted manner.

For example, the heating source 31 may include a heater for heating the interior of the cooking chamber 24.

The cooking apparatus 1 may include a door 18 coupled to the front panel 11 of the main body 10 for opening and closing the cooking chamber 24. The door 18 may be rotatably coupled to the main body 10 to close the cooking chamber 24. At least a portion of the door 18 may be formed of a transparent or translucent material to allow the interior of the cooking chamber 24 to be seen through the portion.

The cooking apparatus 1 may include a control panel 50 including an input portion 51 for receiving a user input and/or a display 52 for displaying information. The control panel 50 may be coupled to the front panel 11 of the main body 10. The control panel 50 may be disposed on one side of the door 18. The control panel 50 may be located at one end opposite to the other end of the front panel 11 at which a hinge 60 rotatably supporting the door 18 is located. The control panel 50 may be integrated into the main body 10.

The display 52 may display a state of the cooking apparatus 1 to a user when the cooking apparatus 1 is stopped/operating. For example, in a case where the cooking object D is being cooked by operation of the cooking apparatus 1, the display 52 may display a required time until the cooking is completed.

The cooking apparatus 1 may include an open button 53 mounted on the control panel 50. The cooking apparatus 1 may open the door 18 in response to manipulation of the open button 53 when the door 18 is in a position to close the cooking chamber 24.

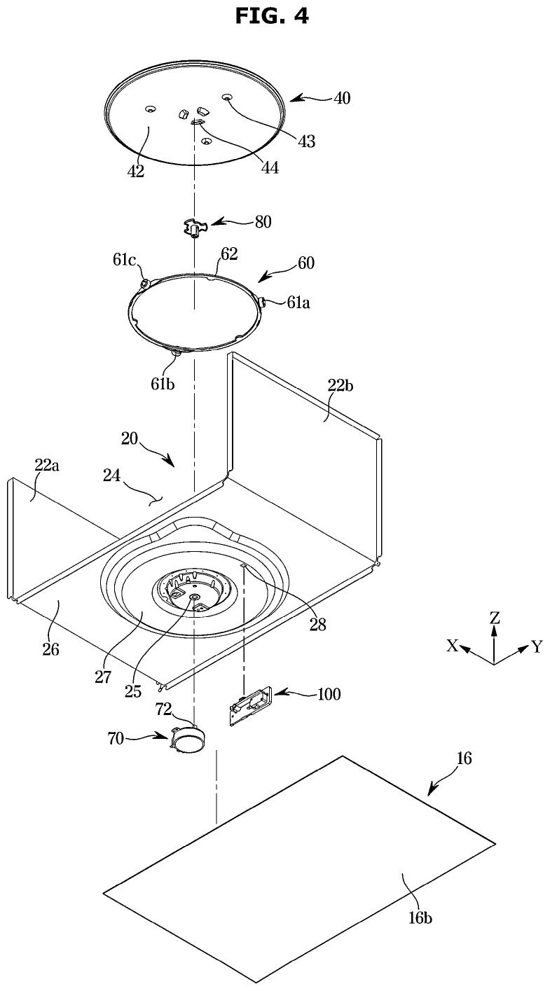

FIG. 3 is an exploded view illustrating only a housing, turntable assembly, signal generator, and bottom cover of a cooking apparatus according to an embodiment. FIG. 4 is a view of FIG. 3 from a different direction.

Referring to FIG. 3 and FIG. 4, the housing 20 may include the internal support surface 21 on which a cooking object D is placed and supported and which forms one surface of the cooking chamber 24. The internal support surface 21 may be defined as the inner surface 21 of the housing. On the opposite side of the inner surface 21 of the housing, an outer surface 26 of the housing may be formed to face downward (−Z direction).

A center hole 25 may be formed on the inner surface of the housing 20. The center hole 25 may be formed to penetrate the inner surface 21 of the housing.

The housing 20 may include the partition walls 22a and 22b formed to protrude upward from both ends of the internal support surface 21 in the left and right directions (+Y direction and −Y direction). The cooking chamber 24 may be surrounded by the internal support surface 21 of the housing 20 and the partition walls 22a and 22b.

The cooking apparatus 1 may include a turntable assembly 40, 60, 70, and 80. The turntable assembly 40, 60, 70, and 80 may include the turntable 40, the motor 70, the coupler 80, and the roller portion 60.

The turntable 40 may have a substantially disk-shaped structure. The turntable 40 may be supported on the inner surface 21 of the housing. The turntable 40 may include a turntable upper surface 41 on which the cooking object Dis placed, and a turntable lower surface 42 formed on the opposite side of the turntable upper surface 41. The turntable upper surface 41 may be disposed in the housing 20 to face the cooking chamber 24. The turntable lower surface 42 may be disposed to face the inner surface 21 of the housing.

The turntable lower surface 42 may include a coupler connection portion 44. A plurality of coupler connection portions 44 may be arranged radially with respect to the center of the turntable 40. The coupler connection portions 44 may be formed to protrude downward (−Z direction) from the turntable lower surface 42.

The turntable lower surface 42 may include a roller support guide portion 43 to be described later. A plurality of roller support guide portions 43 may be arranged radially with respect to the center of the turntable 40. The roller support guide portions 43 may be formed to protrude downward (−Z direction) from the turntable lower surface 42.

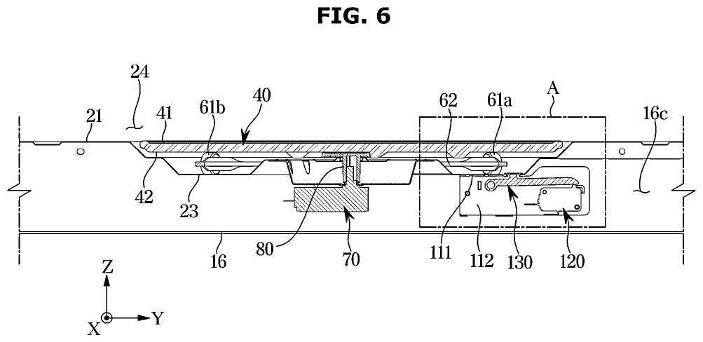

The coupler 80 may be coupled to the coupler connection portions 44 of the turntable 40 to support the turntable 40. The coupler connection portions 44 may be inserted into the center hole 25 and arranged to extend from the cooking chamber 24 toward an outer lower portion 16c (see FIG. 6) of the housing 20.

The coupler 80 may be coupled to the motor 70. The motor 70 may be disposed in the outer lower portion 16c of the housing 20. The motor 70 may include a motor body 71 forming an exterior of the motor. The motor 70 may include a motor rotation shaft 72 protruding from the motor body 71. The motor rotation shaft 72 may be inserted into the coupler 80 and coupled to the coupler 80. When the motor 70 operates, the motor rotation shaft 72 may rotate to rotate the coupler 80. When the coupler 80 rotates, the turntable 40 coupled to the coupler 80 may rotate inside the cooking chamber 24.

The roller portion 60 may be disposed on the inner surface 21 of the housing. The roller portion 60 may include a plurality of rollers 61a, 61b, and 61c arranged to move on the inner surface 21 of the housing, and a roller support 62 that connects and supports the plurality of rollers 61a, 61b, and 61c. The roller support 62 may be guided by the plurality of roller support guide portions 43 and positioned on the lower surface 42 of the turntable 40.

A roller track surface 23 on which the roller 61 moves may be formed on the inner surface 21 of the housing. The roller track surface 23 may be formed in a substantially circular shape on the inner surface 21 of the housing. The roller track surface 23 may have a substantially circular shape centered on the center hole 25. The center hole 25 may be formed to protrude downward (−Z direction) from the inner surface 21 of the housing. The plurality of rollers 61a, 61b, and 61c may move while rotating along the roller track surface 23.

The inner surface 21 of the housing may include a through hole 28 formed on the roller track surface 23. That is, the through hole 28 may be formed in the roller track surface 23. The through hole 28 may be formed to penetrate the roller track surface 23 in order to communicate the cooking chamber 24 with the outer lower portion 16c of the housing 20. The plurality of rollers 61a, 61b, and 61c may pass above the through hole 28 while moving on the roller track surface 23. A diameter of the through hole 28 may be smaller than that of the roller 61. Accordingly, the roller 61 may pass above the through hole 28 without falling into the through hole 28.

The turntable 40 may be supported by the roller 61 and placed to contact with the roller 61. Accordingly, when the turntable 40 rotates, the roller 61 in contact with the turntable 40 may move along the rotation of the turntable 40.

The roller 61 may move while pressing the inner surface 21 of the housing. A magnitude of force F2 with which a single roller 61 presses the inner surface 21 of the housing in a state where there is no cooking object D on the turntable 40 may be calculated by multiplying the gravitational acceleration (approximately 9.8 m/s²) by a value obtained by dividing a sum of a weight of the turntable 40, a weight of the roller support 62, and a total weight of the rollers 61 by the number of rollers 61.

For example, in the drawing, the number of rollers 61 is three, and thus when there is no cooking object D on the turntable 40, the magnitude of the force F2 with which a single roller 61 presses the inner surface 21 of the housing may be calculated by

$$F 2 ( N ) \approx \{ weight ( kg ) of the turntable 40 + weight ( kg ) of the roller support 62 + ( weight ( kg ) of the roller 61 ) \times 3 ) \div 3 \} \times 9.8 ( \frac{m}{{s}^{2}} ) \qquad [ Equation 1 ]$$

However, because the three rollers 61 are only an example of the number of rollers 61, the force F2 with which a single roller 61 presses the inner surface of the housing 20 may vary depending on the number of rollers 61.

The cooking apparatus 1 may include a signal generator 100. The signal generator 100 may be disposed in the outer lower portion 16c of the housing 20. The signal generator 100 may generate an input signal by being pressed by the roller 61. The signal generator 100 will be described later. The motor 70 and the signal generator 100 may be disposed between an outer surface of the housing 20 and the bottom cover 16.

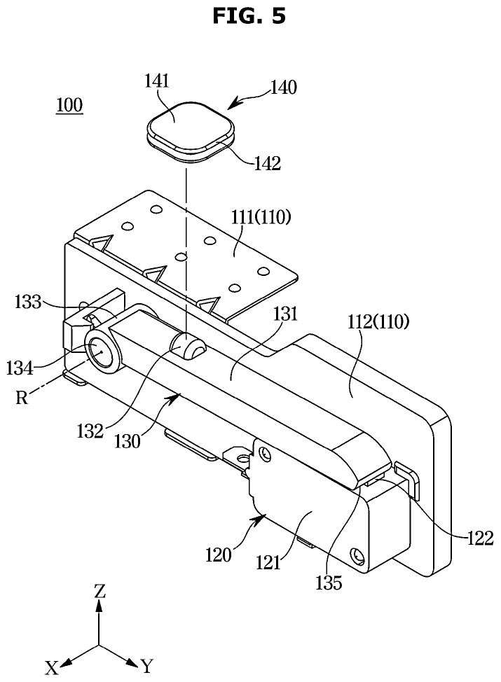

FIG. 5 is a view illustrating a signal generator according to an embodiment.

Referring to FIG. 5, the signal generator 100 may include a lever 130 that is operable and a sensor 120 sensing an operation of the lever 130. The signal generator 100 may include a coupling member 110 coupled to a lever body 131 and the sensor 120 to support the lever body 131 and the sensor 120.

The coupling member 110 may include a first coupling member 111 coupled to the outer lower portion 16c of the housing, and a second coupling member 112 coupled to the first coupling member 111 and formed to extend downward.

The first coupling member 111 may be coupled to an outer lower surface 27 of the housing to support the second coupling member 112. The lever 130 and the sensor 120 may be coupled to the second coupling member 112. The lever 130 and the sensor 120 may be coupled to the second coupling member 112 supported by the first coupling member 111, and may be finally located in the outer lower portion 16c of the housing and be supported by the outer lower surface 27 of the housing.

The lever 130 may include the lever body 131 forming an external shape. The lever 130 may rotate about a rotation axis R located on the lever 130. In other words, an operation of the lever 130 may include a rotational movement based on the rotation axis R.

The lever 130 may include a rotation portion 134 where the rotation axis R is located. The rotation portion 134 may be formed at one end of the lever 130. The rotation portion 134 may be coupled to the second coupling member 112 to support the lever 130.

The sensor 120 may generate an input signal by sensing the operation of the lever 130 when the lever 130 is operated. The sensor 120 may include various types of sensors that detect an operation, such as a switch or an optical sensor. As an example, it is described and shown below that the sensor 120 includes a sensor body 121 and a sensor button 122.

The lever 130 may include a protrusion 132 formed to protrude from an upper surface of the lever body 131 upward (+Z direction). In other words, the protrusion 132 may be formed on the upper surface of the lever body 131 facing the cooking chamber 24.

The lever 130 may include a pressing portion 135 that presses the sensor 120. The pressing portion 135 may be formed at the other end of the lever body 131. The pressing portion 135 may be formed on the lower surface of the lever body 131 in a direction (−Z direction) opposite to the direction toward the cooking chamber 24.

The sensor 120 may include the sensor body 121 that forms an external shape, and the sensor button 122 that protrudes from the sensor body 121. The sensor 120 may include a button support member 123. The button support member 123 may be coupled to the sensor body 121 and may be disposed to support the sensor button 122 on the sensor body 121. The button support member 123 may have elasticity.

When the sensor button 122 is pressed, the button support member 123 may contract based on a magnitude of force acting on the sensor button 122, and the sensor button 122 may move. For example, in a case where the magnitude of the force acting on the sensor button 122 is smaller than an elastic force of the button support member 123, the button support member 123 does not contract, and thus the sensor button 122 may not move. In contrast, in a case where the magnitude of the force acting on the sensor button 122 is greater than the elastic force of the button support member 123, the button support member 123 may contract, and thus the sensor button 122 may move.

The movement of the sensor button 122 by the contraction of the button support member 123 may be defined as an operation of the sensor 120. When the sensor 120 is operated, an input signal may be generated by the sensor 120.

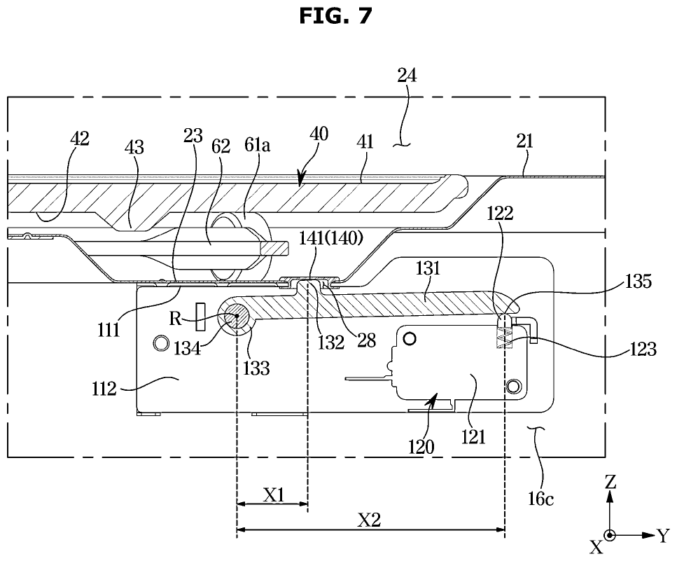

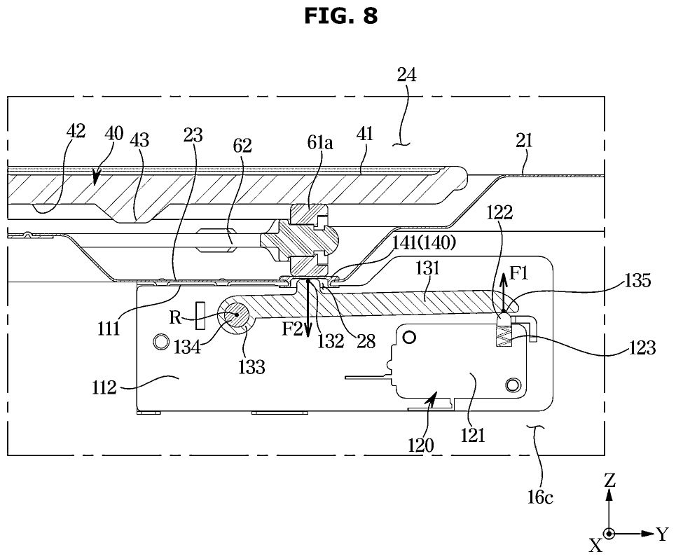

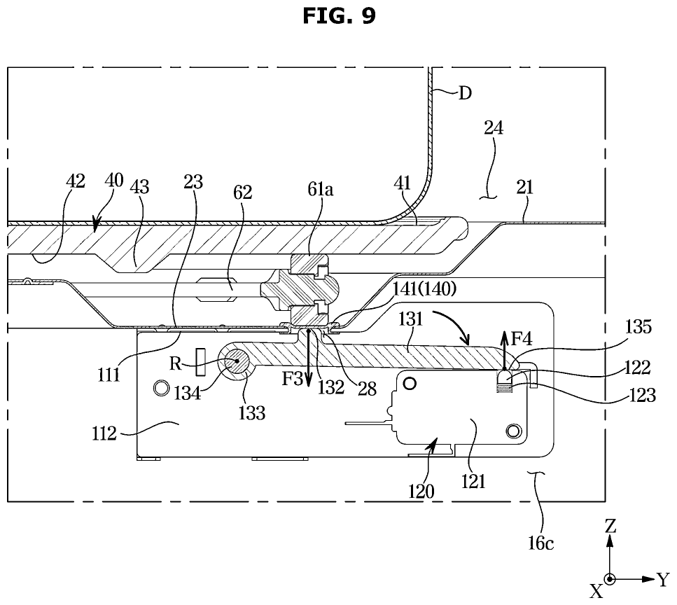

FIG. 6 is a partial cross-sectional view illustrating the coupled housing, turntable assembly, signal generator, and bottom cover of FIG. 3 taken along A-A′. FIG. 7 is an enlarged view of an area A of FIG. 6. FIG. 8 is a view illustrating that when there is no food on the turntable in FIG. 7, a lever does not rotate even though a roller presses a protrusion. FIG. 9 is a view illustrating that when there is food on the turntable in FIG. 7, a roller presses a protrusion and rotates a lever to operate a sensor.

Referring to FIG. 6, FIG. 7, FIG. 8 and FIG. 9, the lever 130 may protrude toward the cooking chamber 24 on the roller track surface 23 and may be pressed by the roller 61. More specifically, the protrusion 132 of the lever 130 may protrude toward the cooking chamber 24 on the roller track surface 23 and may be pressed by the roller 61. The protrusion 132 may be disposed to pass through the through hole 28 and protrude toward the cooking chamber 24.

The roller 61 may move on the roller track surface 23 and may pass above the through hole 28. When the roller 61 passes above the through hole 28, the protrusion 132 of the lever 130 protruding toward the cooking chamber 24 through the through hole 28 may be pressed. When the roller 61 presses the protrusion 132, the lever 130 may be pressed.

Based on the cooking object D being placed on the turntable 40, the lever 130 may be operated by being pressed by the roller 61. The operation of the lever 130 may include a rotational movement based on the rotation axis. In the following description, the operation of the lever 130 is divided into a case where the cooking object D is not placed on the turntable 40 and a case where the cooking object D is placed on the turntable 40.

In a case where the cooking object D is not placed on the turntable 40, the lever 130 may not rotate even when the roller 61 presses the protrusion 132. In other words, when the cooking object D is not placed on the turntable 40, a torque value F2*X1 applied to the lever 130 by the force with which the roller 61 presses the protrusion 132 may be equal to a torque value F1*X2 acting on the lever 130 by the force with which the sensor button 122 applies to the pressing portion 135, which may be expressed as

$$F 2 \times X 1 = F 1 \times X 2 \qquad [ Equation 2 ]$$

F1: Force applied to the pressing portion 135 by the sensor button 122 through the button support member 123, F2: force with which a single roller 61 presses the protrusion 132 when there is no cooking object on the turntable 40, X1: distance from the rotation axis R to the protrusion 132, and X2: distance from the rotation axis R to the pressing portion 135

That is, when the cooking object D is not placed on the turntable 40, the lever 130 may not operate even when the roller 61 presses the protrusion 132 while moving on the roller track surface 23. The operation of the lever 130 may include a rotational movement. Because the lever 130 does not rotate, the sensor button 122 may not move, and thus an input signal may not be generated by the sensor 120.

In a case where the cooking object D is placed on the turntable 40, the lever 130 may rotate when the roller 61 presses the protrusion 132. In other words, when the cooking object D is placed on the turntable 40, a torque value F3*X1 applied to the lever 130 by the force with which the roller 61 presses the protrusion 132 may be greater than a torque value F4*X2 acting on the lever 130 by the force with which the sensor button 122 applies to the pressing portion 135, which may be expressed as

$$F 3 \times X 1 > F 4 \times X 2 \qquad [ Equation 3 ]$$

F3: Force with which a single roller 61 presses the protrusion 132 when the cooking object D is placed on the turntable 40, F4: force applied to the pressing portion 135 by the sensor button 122 through the button support member 123, X1: distance from the rotation axis R to the protrusion 132, X2: distance from the rotation axis R to the pressing portion 135

That is, when the cooking object D is placed on the turntable 40, the roller 61 presses the protrusion 132 while moving on the roller track surface 23, and thus the lever 130 may be operated. The operation of the lever 130 may include a rotational movement. When the lever 130 rotates, the pressing portion 135 may press the sensor button 122 to contract the button support member 123. In this case, the sensor button 122 may move to operate the sensor 120. When the sensor 120 operates, the sensor 120 may generate an input signal.

The protrusion 132 may be disposed between the rotation portion 134 and the pressing portion 135. Accordingly, when the lever 130 rotates about the rotation axis R located on the rotation portion 134, a distance where the protrusion 132 moves by being pressed may be less than a distance where the pressing portion 135 moves.

In a case where the protrusion 132 is pressed and the lever 130 rotates, the pressing portion 135 moves longer than the distance where the protrusion 132 moves, thereby allowing the sensor button 122 to move. As a result, the lever 130 may effectively press and move the sensor button 122. In addition, even when the protrusion 132 moves a shorter distance by being pressed, the distance where the pressing portion 135 moves may be secured, thereby reducing the extent to which the protrusion 132 protrudes. Accordingly, when the roller 61 passes above the protrusion 132, a gap between the roller track surface 23 and the protrusion 132 may be reduced, thereby allowing the roller 61 to be moved more stably.

The sensor 120 may be spaced apart from the through hole 28. More specifically, the sensor 120 may be spaced apart from the through hole 28 in a radial direction of the turntable 40. In a case where the cooking object D is placed on the turntable 40, due to the rotation of the turntable 40, a portion of the cooking object D may spill onto the inner surface 21 of the housing slightly away from the turntable 40. In this case, the cooking object D may pass through the through hole 28 and flow to the outer lower portion 16c of the housing 20. However, because the sensor 120 is disposed to be spaced apart from the through hole 28, damage caused by the spilled cooking object D may be prevented.

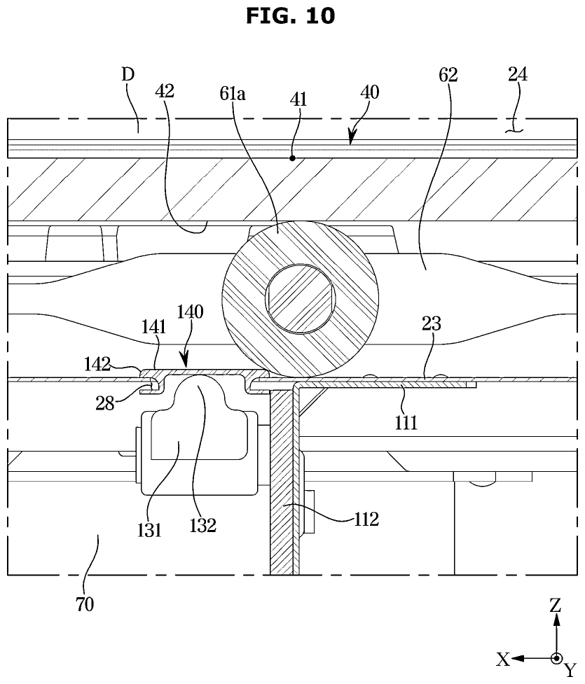

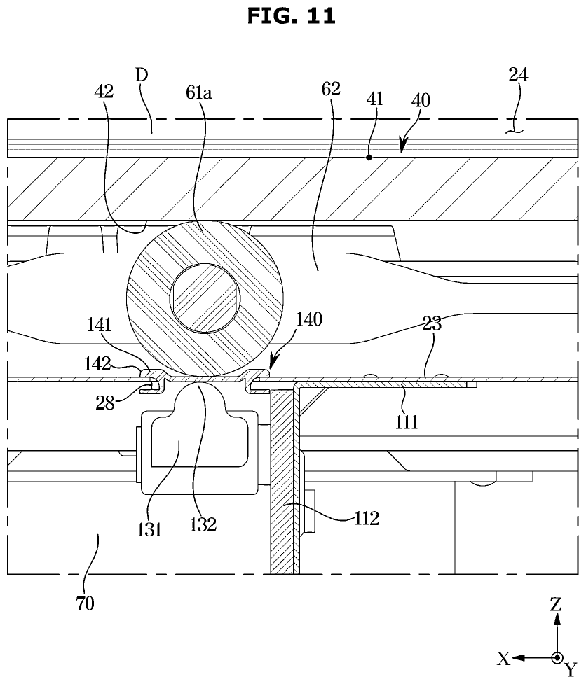

FIG. 10 is a partial cross-sectional view illustrating the coupled housing, turntable assembly, signal generator, and bottom cover of FIG. 3 taken along B-B′. FIG. 11 is a view illustrating a roller of FIG. 10 moves past an inclined surface of a through hole cover to a support surface.

Referring to FIG. 10 and FIG. 11, the lever 130 may include a through hole cover 140. The through hole cover 140 may be coupled to the protrusion 132. The through hole cover 140 may be coupled to the protrusion 132 to cover an upper side of the protrusion 132.

The through hole cover 140 may be inserted into the through hole 28. When the through hole cover 140 is inserted into the through hole 28, the through hole 28 may be covered. The through hole cover 140 may be in close contact with the inner surface of the housing 20. Because the through hole cover 140 is in close contact with the inner surface of the housing 20, the cooking object D may be blocked from flowing through the through hole 28.

The through hole cover 140 may include an elastic material. Accordingly, when covering the through hole 28, the through hole cover 140 may more effectively come into close contact with the inner surface of the housing 20.

When the roller 61 moves on the roller track surface 23, the roller 61 may pass above the through hole 28 while pressing the through hole cover 140. In a case where the roller 61 presses the through hole cover 140, the through hole cover 140 may press the protrusion 132.

The through hole cover 140 may include a support surface 141 to support the roller 61. The support surface 141 may protrude from the inner surface 21 of the housing toward the cooking chamber 24. When the roller 61 moves on the roller track surface 23 and passes above the through hole 28, the roller 61 may move while being supported by the support surface 141.

In a case where the cooking object D is placed on the turntable 40, when the roller 61 presses the protrusion 132 by pressing the cover of the through hole 28, the lever 130 may rotate. When the lever 130 rotates, the support surface 141 may be recessed along the movement of the protrusion 132.

The through hole cover 140 may include an inclined surface 142 formed to guide the roller 61 from the roller track surface 23 to the support surface 141. The inclined surface 142 may extend from the roller track surface 23 to the support surface 141.

Because the support surface 141 protrudes from the roller track surface 23 toward the cooking chamber 24, a step may be formed between the support surface 141 and the roller track surface 23. Because the inclined surface 142 extends from the roller track surface 23 toward the support surface 141, the roller 61 may move smoothly over the through hole cover 140.

The inclined surface 142 may be curved toward the cooking chamber 24. Because the inclined surface 142 is formed to be curved toward the cooking chamber 24, the roller 61 may move more smoothly from the roller track surface 23 to the support surface 141 despite the step. As a result, noise generated by the step when the roller 61 moves may be reduced.

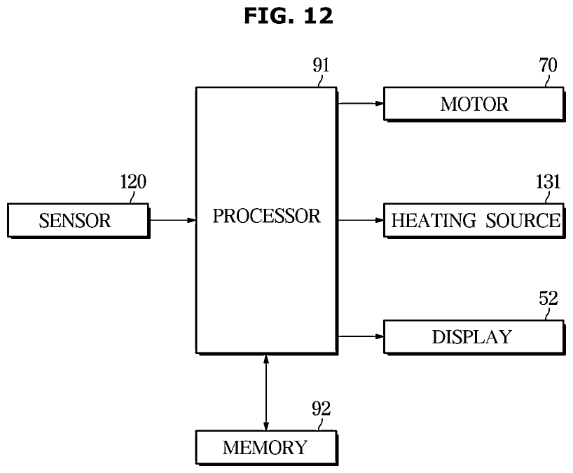

FIG. 12 is a control block diagram illustrating a process of controlling a heating source, a motor, and a display of a cooking apparatus according to an embodiment.

Referring to FIG. 12, the cooking apparatus 1 may include a processor 91. The processor 91 may be electrically connected to the sensor 120, the motor 70, the heating source 31, and the display 52. The processor 91 may receive an input signal generated by the sensor 120.

The processor 91 may control operations of the motor 70, the heating source 31, and the display 52 based on the received input signal.

The cooking apparatus 1 may include a memory 92 electrically connected to the processor 91. The memory 92 may store information and an algorithm for controlling the sensor 120, the motor 70, the heating source 31, and the display 52, or data about a program that reproduces the algorithm.

The memory 92 and the processor 91 may be implemented as separate chips. Alternatively, the memory 92 and processor 91 may be implemented as a single chip.

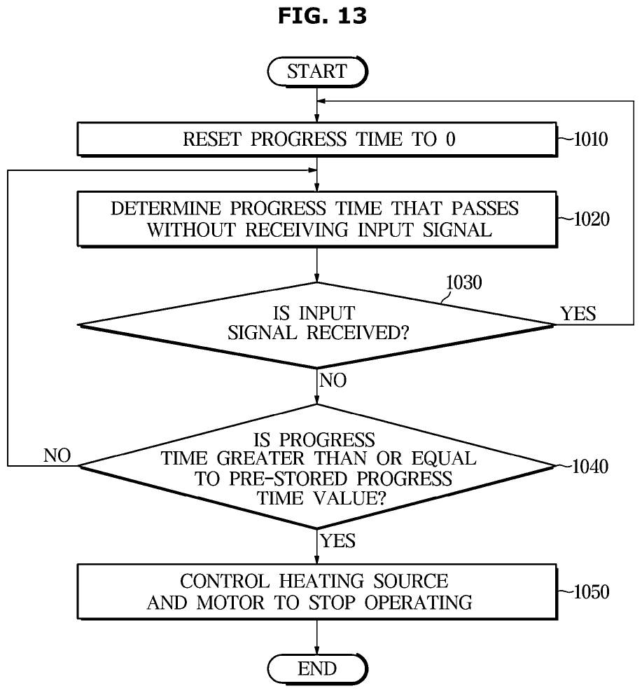

FIG. 13 is a flowchart illustrating a method of controlling a heating source and a motor based on whether a processor receives an input signal in a cooking apparatus according to an embodiment.

Referring to FIG. 13, the processor 91 may count time. In other words, the processor 91 may count the time that an input signal is received, or count the time that passes (elapses) without receiving an input signal.

There may be various cases in which the processor 91 may not receive the input signal. For example, a case where the processor 91 may not receive an input signal may include a state in which the turntable 40 does not rotate. The state in which the turntable 40 does not rotate may indicate a state where the motor 70 is not operated, a state where the turntable 40 and the coupler 80 are not coupled, a state where the coupler 80 and the motor 70 are not coupled, and the like. In addition, a case when the processor 91 may not receive an input signal may be a case where the cooking object D is not placed on the turntable 40. However, all of the above cases are merely examples of cases where the processor 91 may not receive an input signal, and the case where the processor 91 may not receive an input signal is not limited to the above examples.

The processor 91 may determine a progress time. The progress time may refer to a time that passes (elapses) without an input signal being received by the processor 91.

When the heating source 31 and the motor 70 operate, the processor 91 may reset the progress time to 0 (1010). Thereafter, when the heating source 31 and the motor 70 operate, in a case where the processor 91 may not receive the input signal, the processor 91 may count the time that passes without receiving the input signal according to an algorithm stored in the memory 92, thereby determining the progress time (1020).

Thereafter, when the processor 91 receives the input signal (1030), the processor 91 may reset the determined progress time to 0 again, and repeat the above-described process (1020).

In a case where the processor 91 may not receive the input signal, the processor 91 may compare the determined progress time with a pre-stored progress time value (1040).

The progress time value may be pre-stored in the memory 92 electrically connected to the processor 91.

In a case where the determined progress time is less than the progress time value pre-stored in the memory 92, the processor 91 may not perform a control to stop the operation of the heating source 31 and the motor 70. That is, the processor 91 may continue to count the time that passes without receiving the input signal.

In a case where the determined progress time is greater than or equal to the progress time value pre-stored in the memory 92, the processor 91 may control the heating source 31 and the motor 70 to stop operating (1050). As described above, the case in which the processor 91 may not receive the input signal may include a case in which the turntable 40 does not rotate, a state in which the turntable 40 rotates without food thereon, and the like. Accordingly, by controlling the heating source 31 and the motor 70 to stop operating by the processor 91, safety of use of the cooking apparatus 1 may be improved.

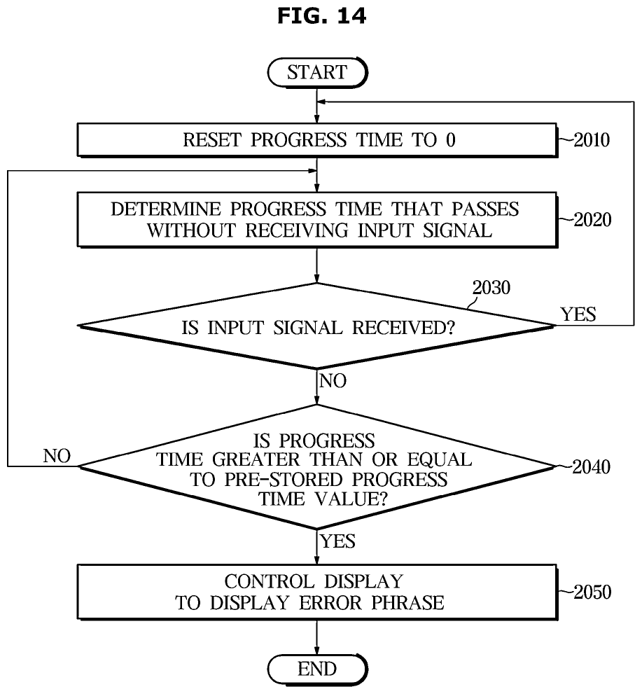

FIG. 14 is a flowchart illustrating a method of controlling a display based on whether a processor receives an input signal in a cooking apparatus according to an embodiment. Details of redundant descriptions thereof will be omitted below.

Referring to FIG. 14, the processor 91 may count time. In other words, the processor 91 may count the time that an input signal is received, or count the time that passes without receiving an input signal.

The processor 91 may determine a progress time. The progress time may refer to a time that passes without an input signal being received by the processor 91.

When the heating source 31 and the motor 70 operate, the processor 91 may reset the progress time to 0 (2010).

Thereafter, when the heating source 31 and the motor 70 operate, in a case where the processor 91 may not receive an input signal, the processor 91 may determine the progress time by counting the time that passes without receiving the input signal according to an algorithm stored in the memory 92 (2020).

Thereafter, when the processor 91 receives the input signal (2030), the processor 91 may reset the determined progress time to 0 again, and repeat the above-described process (2020).

When the processor 91 may not receive an input signal, the processor 91 may compare the determined progress time with a pre-stored progress time value (2040).

The progress time value may be pre-stored in the memory 92 electrically connected to the processor 91.

In a case where the determined progress time is less than the progress time value pre-stored in the memory 92, the processor 91 may not control the display 52. That is, the processor 91 may continue to count the time that passes without receiving the input signal.

In a case where the determined progress time is greater than or equal to the progress time value pre-stored in the memory 92, the processor 91 may control the display 52 to display a pre-stored error phrase (2050). As described above, the case in which the processor 91 may not receive an input signal may include a case in which the turntable 40 does not rotate, a state in which the turntable 40 rotates without food thereon, and the like. Accordingly, by controlling the display 52 to display the error phrase by the processor 91, a user may intuitively recognize that an error has occurred in the operation of the cooking apparatus 1 and respond accordingly. As a result, the cooking apparatus 1 may be effectively managed and safety of use of the cooking apparatus 1 may be improved.

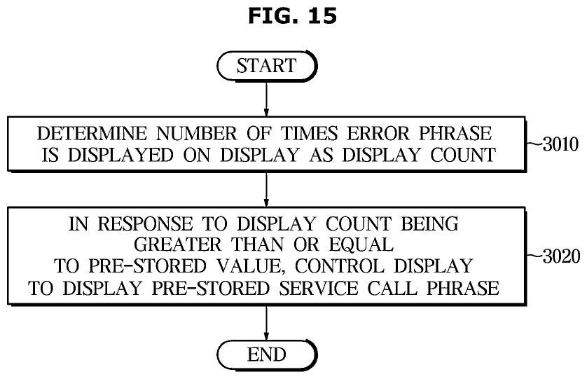

FIG. 15 is a flowchart illustrating a method in which a processor controls a display based on a display count in a cooking apparatus according to an embodiment. Details of redundant descriptions thereof will be omitted below.

Referring to FIG. 15, the processor 91 may determine the number of times an error phrase is displayed on the display 52 as a ‘display count’ using an algorithm stored in the memory 92 (3010).

Thereafter, the processor 91 may compare the display count with a value pre-stored in the memory 92. In a case where the display count is less than the value pre-stored in the memory 92, the processor 91 may not control the display 52.

In a case where the display count is greater than or equal to the value pre-stored in the memory 92, the processor 91 may control the display 52 to display a service call phrase pre-stored in the memory 92 (3020).

In a case where the number of times the error phrase is displayed is greater than or equal to the pre-stored value, a defect may have occurred in the cooking apparatus 1. Accordingly, a user may view the displayed service call phrase, and may request repair of the cooking apparatus 1 to a repair center, and the like, and thus efficiency of management of the cooking apparatus 1 may be increased and safety of use may be improved.

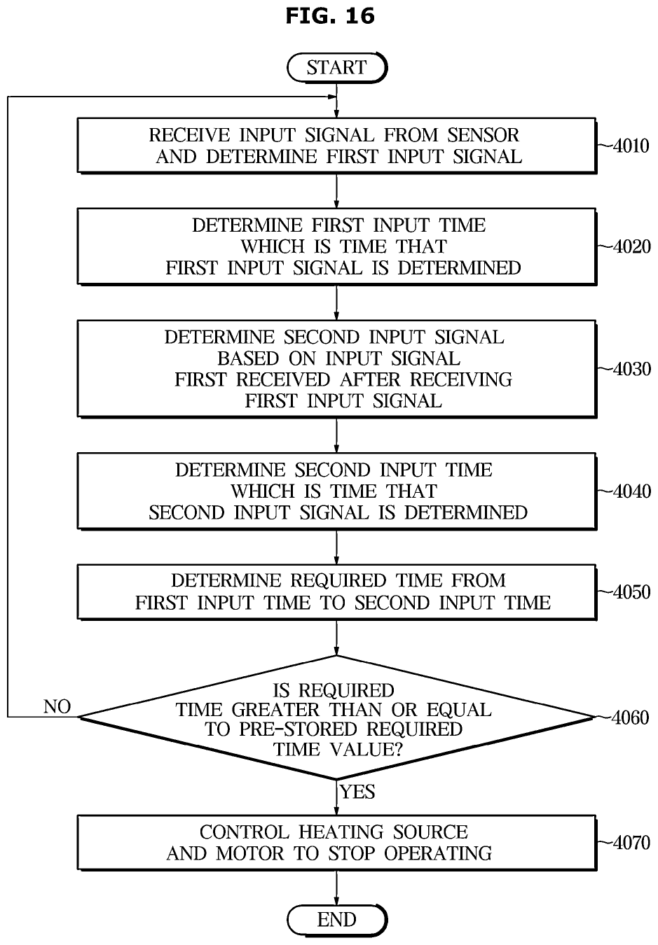

FIG. 16 is a flowchart illustrating a method in which a processor controls a heating source and a motor in response to receiving an input signal, in a cooking apparatus according to an embodiment.

Referring to FIG. 16, the processor 91 may count time. In other words, the processor 91 may count the time that an input signal is received, or count the time that passes without receiving an input signal.

As described above, when the turntable 40 rotates and the roller 61 operates the sensor 120, an input signal may be generated by the sensor 120. The processor 91 may receive the input signal from the sensor 120.

The processor 91 may determine the input signal received from the sensor 120 as a first input signal according to an algorithm stored in the memory 92 (4010). The processor 91 may determine a first input time, which is the time at which the first input signal is determined, based on the determined first input signal (4020).

The processor 91 may determine, as a second input signal, an input signal first received from the sensor 120 after the first input signal is received according to the algorithm stored in the memory 92 (4030). The processor 91 may determine a second input time, which is the time at which the second input signal is determined, based on the determined second input signal (4040).

The processor 91 may determine a required time, which is the time from the first input time to the second input time, based on the first input time and the second input time (4050). In other words, the required time may correspond to the time it takes for the next roller 61 to press the lever 130 after the roller 61 presses the lever 130.

The processor 91 may compare the required time with a required time value pre-stored in the memory 92 (4060).

In a case where the required time is less than the pre-stored required time value, the processor 91 may not perform a control to stop the operation of the heating source 31 and the motor 70.

In a case where the required time is greater than or equal to the required time value pre-stored in the memory 92, the processor 91 may control the heating source 31 and the motor 70 to stop operating (4070).

As described above, the time taken for the roller 61 to press the lever 130 and for the next roller 61 to press the lever 130 may correspond to the required time. The required time greater than the pre-stored required time value may indicate that the time taken for the roller 61 to rotate along the roller track surface 23 is longer than intended, which may indicate that the turntable 40 rotates slower than intended, causing an error in safety of use of the cooking apparatus 1. Accordingly, in a case where the required time is greater than or equal to the required time value, the processor 91 may control the heating source 31 and the motor 70 to stop operating, and thus the safety of use in the cooking apparatus 1 may be improved.

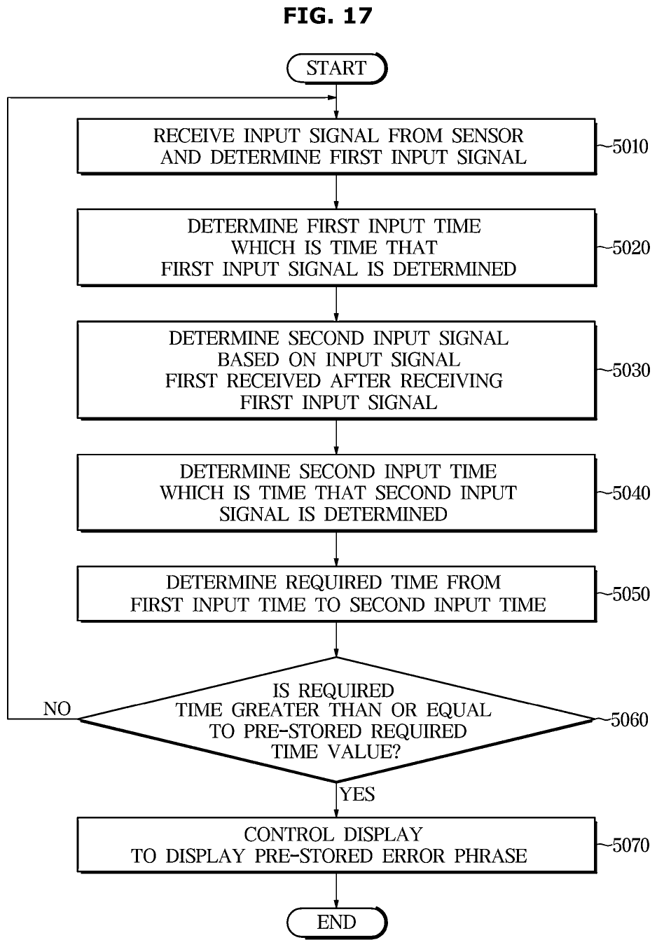

FIG. 17 is a flowchart illustrating a method in which a processor controls a display in response to receiving an input signal, in a cooking apparatus according to an embodiment. Details of redundant descriptions thereof will be omitted below.

Referring to FIG. 17, the processor 91 may determine, as a first input signal, an input signal received from the sensor 120 according to an algorithm stored in the memory 92 (5010). The processor 91 may determine a first input time, which is the time at which the first input signal is determined, based on the determined first input signal (5020).

The processor 91 may determine, as a second input signal, an input signal first received from the sensor 120 after the first input signal is received according to the algorithm stored in the memory 92 (5030). The processor 91 may determine a second input time, which is the time at which the second input signal is determined, based on the determined second input signal (5040).

The processor 91 may determine a required time, which is the time from the first input time to the second input time, based on the first input time and the second input time (5050). In other words, the required time may correspond to the time it takes for the next roller 61 to press the lever 130 after the roller 61 presses the lever 130.

The processor 91 may compare the required time with a required time value pre-stored in the memory 92 (5060).

In a case where the determined required time is less than the required time value pre-stored in the memory 92, the processor 91 may not control the display 52.

In a case where the determined required time is greater than or equal to the required time value pre-stored in the memory 92, the processor 91 may control the display 52 to display a pre-stored error phrase (5070). As described above, a case where the required time is greater than or equal to the required time value may include a case where the turntable 40 rotates at a slower speed than intended. Accordingly, by controlling the display 52 to display the error phrase on the display 52 by the processor 91, a user may intuitively recognize that an error has occurred in the operation of the cooking apparatus 1 and respond accordingly. As a result, the cooking apparatus 1 may be effectively managed and safety of use of the cooking apparatus 1 may be improved.

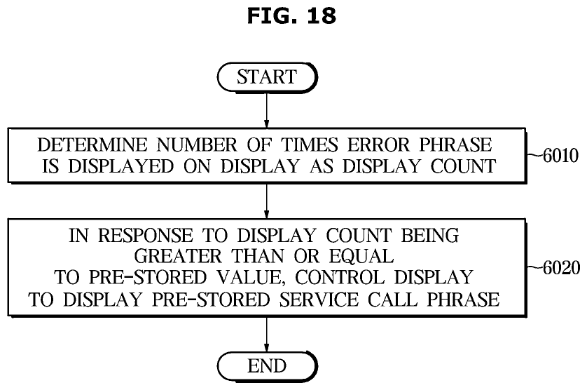

FIG. 18 is a flowchart illustrating a method in which a processor controls a display based on a display count in a cooking apparatus according to an embodiment.

Referring to FIG. 18, the processor 91 may determine the number of times an error phrase is displayed on the display 52 as a ‘display count’ using an algorithm stored in the memory 92 (6010).

Thereafter, the processor 91 may compare the display count with a value pre-stored in the memory 92. In a case where the display count is less than the value pre-stored in the memory 92, the processor 91 may not control the display 52.

In a case where the display count is greater than or equal to the pre-stored value, the processor 91 may control the display 52 to display a service call phrase pre-stored in the memory 92 (6020). In a case where the number of times the error phrase is displayed is greater than or equal to the pre-stored value, a defect may have occurred in the cooking apparatus 1. Accordingly, a user may view the displayed service call phrase, and may request repair of the cooking apparatus 1 to a repair center, and the like, and thus efficiency of management of the cooking apparatus 1 may be increased and safety of use may be improved.

According to an embodiment of the disclosure, a cooking apparatus 1 may include a housing 20 configured to form a cooking chamber 24. The cooking apparatus 1 may include a heating source 31 configured to heat an inside of the cooking chamber 24. The cooking apparatus 1 may include a turntable 40 on which an object to be cooked is placed and configured to be connected to a motor 70 and rotatably disposed in the cooking chamber 24. The cooking apparatus 1 may include a roller 61 configured to support the turntable 40 and be movable according to rotation of the turntable 40 on a roller track surface 23 formed on an inner surface of the housing 20. The cooking apparatus 1 may include a lever 130 configured to protrude toward the cooking chamber 24 on the roller track surface 23 so as to be pressed by the roller 61, and configured to be operated by pressure from the roller 61 based on whether the object to be cooked is placed on the turntable 40. The cooking apparatus 1 may include a sensor 120 configured to sense an operation of the lever 130 upon the operation of the lever 130 to generate an input signal. An operation of the heating source 31 and the motor 70 may be controlled based on the input signal.

The operation of the lever 130 may include a rotational movement based on a rotation axis R located on the lever 130. The sensor 120 may be configured to generate the input signal by being pressed by the rotational movement of the lever 130. The lever 130 may include a protrusion 132 configured to protrude toward the cooking chamber 24 on the roller track surface 23 so as to be pressed by the roller 61. The lever 130 may further include a rotation portion 134 in which the rotation axis of the lever 130 is located, and a pressing portion 135 configured to press the sensor 120. The protrusion 132 may be disposed between the rotation portion 134 and the pressing portion 135.

The lever 130 may further include a lever body 131 configured to rotate based on the rotation axis R. The protrusion 132 may be formed on an upper surface of the lever body 131 toward the cooking chamber 24. The pressing portion 135 may be formed below the lever body 131.

The lever 130 may be configured to be operated by the pressure from the roller 61 in a case where the object to be cooked is placed on the turntable 40. In a case where the object to be cooked is not placed on the turntable 40, the lever 130 may be configured not to operate even when pressed by the roller 61.

An inner surface 21 of the housing 20 may include a through hole 28 formed on the roller track surface 23. The protrusion 132 may be disposed to pass through the through hole 28 and protrude toward the cooking chamber 24.

The sensor 120 may be spaced apart from the through hole 28 in a radial direction of the turntable 40.

The lever 130 may further include a through hole cover 140 configured to be coupled to the protrusion 132 and be inserted into the through hole 28 to cover the through hole 28. The through hole cover 140 may be configured to press the protrusion 132 by being pressed by the roller 61.

The through hole cover 140 may include a support surface 141 configured to support the roller 61. The through hole cover 140 may include an inclined surface 142 configured to extend from the roller track surface 23 toward the support surface 141, and formed by curving toward the cooking chamber 24 so as to guide the roller 61 to the support surface 141 from the roller track surface 23.

The cooking apparatus 1 may further include a processor 91 configured to be electrically connected to the sensor 120 to receive the input signal. The processor 91 may be configured to control the operation of the heating source 31 and the motor 70 based on the input signal.

The processor 91 may be configured to count time. The processor 91 may be configured to determine a progress time that passes without receiving the input signal (1020). The processor 91 may be configured to control the heating source 31 and the motor 70 to stop operating (1050) in response to the progress time being greater than or equal to a pre-stored progress time value (1040).

The cooking apparatus 1 may further include a display 52 configured to be electrically connected to the processor 91. The processor 91 may be configured to control the display 52 to display a pre-stored error phrase (2050) in response to the progress time being greater than or equal to the pre-stored progress time value (2040).

The processor 91 may be configured to determine a number of times the error phrase is displayed on the display 52 as a display count (3010). The processor 91 may be configured to control the display 52 to display a pre-stored service call phrase in response to the display count being greater than or equal to a pre-stored value (3020).

The processor 91 may be configured to count time. The processor 91 may be configured to determine a first input signal based on the input signal upon receiving the input signal (4010). The processor 91 may be configured to determine a first input time based on the first input signal, the first input time being a time that the first input signal is determined (4020). The processor 91 may be configured to determine a second input signal based on an input signal first received after receiving the first input signal (4030). The processor 91 may be configured to determine a second input time based on the second input signal, the second input time being a time that the second input signal is determined (4040). The processor 91 may be configured to determine a required time from the first input time to the second input time, based on the first input time and the second input time (4050). The processor 91 may be configured to control the heating source 31 and the motor 70 to stop operating (4060), in response to the required time being greater than or equal to a pre-stored required time value (4050).

The cooking apparatus 1 may further include a display 52 configured to be electrically connected to the processor 91. The processor 91 may be configured to control the display 52 to display a pre-stored error phrase (5070), in response to the required time being greater than or equal to the pre-stored required time value (5060).

The processor 91 may be configured to determine a number of times the error phrase is displayed on the display 52 as a display count (6010). The processor 91 may be configured to control the display 52 to display a pre-stored service call phrase (6020), in response to the display count being greater than or equal to a pre-stored value.

According to an embodiment of the disclosure, a cooking apparatus 1 may include a housing 20 configured to form a cooking chamber 24. The cooking apparatus 1 may include a heating source 31 configured to heat an inside of the cooking chamber 24. The cooking apparatus 1 may include a turntable 40 on which an object to be cooked is placed and configured to be connected to a motor 70 and rotatably disposed in the cooking chamber 24. The cooking apparatus 1 may include a roller 61 configured to support the turntable 40 and be movable according to rotation of the turntable 40 on an inner surface 21 of the housing 20. The cooking apparatus 1 may include a lever 130 including a protrusion 132 configured to protrude toward the cooking chamber 24 on the inner surface 21 of the housing 20 so as to be pressed by the roller 61. The lever 130 may be configured to be operated by pressure from the roller 61 based on whether the object to be cooked is placed on the turntable 40. The cooking apparatus 1 may include a sensor 120 configured to sense an operation of the lever 130 upon the operation of the lever 130 to generate an input signal. The cooking apparatus 1 may include a processor 91 configured to be electrically connected to the sensor 120 to receive the input signal. The processor 91 may control an operation of the heating source 31 and the motor based on the input signal.

The inner surface 21 of the housing 20 may include a roller track surface 23 on which the roller 61 moves and a through hole 28 formed on the roller track surface 23. The protrusion 132 may be disposed to pass through the through hole 28 and protrude toward the cooking chamber 24.

The operation of the lever 130 may include a rotational movement based on a rotation axis R located on the lever 130. The sensor 120 may be configured to generate the input signal by being pressed by the rotational movement of the lever 130. The lever 130 may further include a rotation portion 134 in which the rotation axis of the lever 130 is located, and a pressing portion 135 configured to press the sensor 120. The protrusion 132 may be disposed between the rotation portion 134 and the pressing portion 135.

The cooking apparatus 1 may further include a display 52 configured to be electrically connected to the processor 91. The processor 91 may be configured to count time. When the processor 91 may not receive the input signal, the processor 91 may be configured to determine a progress time that passes without receiving the input signal (1020). The processor 91 may be configured to control the heating source 31 and the motor 70 to stop operating (1050), in response to the progress time being greater than or equal to a pre-stored progress time value (1040), and may be configured to control the display 52 to display a pre-stored error phrase (2050).

The cooking apparatus 1 may further include a display 52 configured to be electrically connected to the processor 91. The processor 91 may be configured to count time. The processor 91 may be configured to determine a first input signal based on the input signal upon receiving the input signal (4010). The processor 91 may be configured to determine a first input time based on the first input signal, the first input time being a time that the first input signal is determined (4020). The processor 91 may be configured to determine a second input signal based on an input signal first received after receiving the first input signal (4030). The processor 91 may be configured to determine a second input time based on the second input signal, the second input time being a time that the second input signal is determined (4040). The processor 91 may be configured to determine a required time from the first input time to the second input time, based on the first input time and the second input time (4050). The processor 91 may be configured to control the heating source 31 and the motor 70 to stop operating (4070), in response to the required time being greater than or equal to a pre-stored required time value (4060), and may be configured to control the display 52 to display a pre-stored error phrase (5070).

According to an aspect of the disclosure, in a case where a roller may not press and rotate a lever because a turntable does not rotate, a sensor may not generate an input signal, and a heating source and a motor may be controlled to stop operating, thereby improving safety of use.

According to an aspect of the disclosure, in a case where a roller may not press and rotate a lever because a turntable does not rotate, a sensor may not generate an input signal, and a display may be controlled to display a phrase, thereby allowing a user to confirm whether the turntable rotates, and improving safety of use.

According to an aspect of the disclosure, in a case where a roller may not press and rotate a lever even though a turntable rotates because no cooking object is placed on the turntable, a sensor may not generate an input signal, and a heating source and a motor may be controlled to stop operating, thereby improving safety of use.

According to an aspect of the disclosure, in a case where a roller may not press and rotate a lever even though a turntable rotates because no cooking object is placed on the turntable, a sensor may not generate an input signal, and a display may be controlled to display a phrase, thereby allowing a user to confirm whether a cooking object is placed on the turntable, and improving safety of use.

The effects that may achieved by the disclosure are not limited to the above-mentioned effects, and other effects not mentioned will be clearly understood by one of ordinary skill in the technical art to which the disclosure belongs from the following description.

Although embodiments of the disclosure have been described with reference to the accompanying drawings, a person having ordinary skilled in the art will appreciate that other specific modifications may be easily made without departing from the technical spirit or essential features of the disclosure. Accordingly, the foregoing embodiments should be regarded as illustrative rather than limiting in all aspects.

1. A cooking apparatus, comprising:
a housing forming a cooking chamber;
a turntable in the cooking chamber on which an object to be cooked is placeable;
a motor configured to rotate the turntable;
a heating source configured to heat the object to be cooked on the turntable inside the cooking chamber;
a roller supporting the turntable and which is movable, according to rotation of the turntable by the motor, on a roller track surface formed on an inner surface of the housing;
a lever protruding from the roller track surface toward the cooking chamber and configured to be pressable by pressure from the roller, and thereby operated, when the object to be cooked is on the turntable and the roller moves over the lever; and
a sensor configured to sense that the lever is operated by pressure from the roller and to generate a signal corresponding to the lever being operated,
wherein an operation of the heating source and the motor is controlled based on the signal.

2. The cooking apparatus of claim 1, wherein
the lever further includes:
a rotation portion which is rotatable about a rotation axis of the lever,
a pressing portion configured to press the sensor based on rotation of the rotation portion, and
a protrusion between the rotation axis and the pressing portion, protruding from the roller track surface toward the cooking chamber, and configured to be pressable by the pressure from the roller, and
the sensor generates the signal by being pressed by a rotational movement of the lever about the rotation axis.

3. The cooking apparatus of claim 2, wherein
the lever further includes:
a lever body configured to rotate about the rotation axis, and
the protrusion protrudes from an upper surface of the lever body toward the cooking chamber, and
the pressing portion is on a lower surface of the lever body.

4. The cooking apparatus of claim 1, wherein the lever is not operated by the pressure from the roller when the roller moves over the lever without an object being on the turntable.

5. The cooking apparatus of claim 2, wherein
the inner surface of the housing includes a through hole formed through the roller track surface, and
the protrusion passes through the through hole and protrudes toward the cooking chamber.

6. The cooking apparatus of claim 5, wherein the sensor is spaced apart from the through hole in a radial direction of the turntable.

7. The cooking apparatus of claim 5, wherein the lever further includes:
a through hole cover which is coupled to the protrusion and inserted into the through hole to cover the through hole, and
the through hole cover presses the protrusion when the through hole cover is pressed by the roller.

8. The cooking apparatus of claim 7, wherein the through hole cover includes:
a support surface to support the roller when the roller moves over the through hole cover, and
an inclined surface extending from the roller track surface toward the support surface, and curved toward the cooking chamber to guide the roller to the support surface from the roller track surface.

9. The cooking apparatus of claim 1, further comprising:
a processor configured to receive the signal,
wherein the processor is further configured to control the operation of the heating source and the motor based on the signal.

10. The cooking apparatus of claim 9, wherein the processor is further configured to:
count time,
determine a progress time that elapsed without receiving the signal, and
stop the operation of the heating source and the motor in response to the progress time being greater than or equal to a pre-stored progress time.

11. The cooking apparatus of claim 10, further comprising:
a display connected to the processor,
wherein the processor is further configured to control the display to display a pre-stored error phrase in response to the progress time being greater than or equal to the pre-stored progress time.

12. The cooking apparatus of claim 11, wherein the processor is further configured to:
determine a display count of a number of times the pre-stored error phrase is displayed on the display, and
control the display to display a pre-stored service call phrase in response to the display count being greater than or equal to a pre-stored value.

13. The cooking apparatus of claim 9, wherein the processor is further configured to:
count time,
determine a first input signal based on receiving the signal,
determine a first input time based on a time that the first input signal is determined,
determine a second input signal based on the signal first received after determining the first input signal,
determine a second input time based on a time that the second input signal is determined,
determine a required time from time elapsed between the first input time and the second input time, and
stop the operation of the heating source and the motor in response to the required time being greater than or equal to a pre-stored required time.

14. The cooking apparatus of claim 13, further comprising:
a display connected to the processor,
wherein the processor is further configured to control the display to display a pre-stored error phrase in response to the required time being greater than or equal to the pre-stored required time.

15. The cooking apparatus of claim 14, wherein the processor is further configured to:
determine a display count of a number of times the pre-stored error phrase is displayed on the display, and
control the display to display a pre-stored service call phrase in response to the display count being greater than or equal to a pre-stored value.
